(19) United States
(12) Patent Application Publication
(10) Pub. No.: US 2021/0185235 A1
(43) Pub. Date: Jun. 17, 2021

(54) INFORMATION PROCESSING DEVICE, IMAGING CONTROL METHOD, PROGRAM AND RECORDING MEDIUM

(71) Applicant: SZ DJI TECHNOLOGY CO., LTD., Shenzhen (CN)

(72) Inventors: Lei GU, Shenzhen (CN); Sijie SHEN, Shenzhen (CN)

(21) Appl. No.: 17/187,019

(22) Filed: Feb. 26, 2021

Related U.S. Application Data
(63) Continuation of application No. PCT/CN2019/101753, filed on Aug. 21, 2019.

(30) Foreign Application Priority Data
Aug. 29, 2018 (JP) 2018-160605

(51) Int. Cl. H04N 5/232; B64C 39/02

(52) U.S. Cl. CPC H04N 5/23299; B64C 2201/123; B64C 39/024; H04N 5/23203

(57) ABSTRACT

The present disclosure provides an information processing device for generating imaging control information for imaging an object by a moving body. The information processing device includes a processing unit configured to obtain shape information of the object to be imaged; generate a moving path for imaging a side of the object to be imaged based on an imaging distance corresponding to the shape information; set an imaging position on the moving path; and set an imaging direction at the imaging position based on a normal direction of the side of the object to be imaged.

### CROSS-REFERENCE TO RELATED APPLICATIONS

This application is a continuation of International Application No. PCT/CN2019/101753, filed on Aug. 21, 2019, which claims priority to Japanese Application No. 2018-160605, filed Aug. 29, 2018, the entire contents of both of which are incorporated herein by reference.

### TECHNICAL FIELD

The present disclosure relates to an information process device, an imaging control method, a program, and a recording medium for controlling the image recording of a mobile object.

### BACKGROUND

JP 2010-61216 discloses a platform (e.g., an unmanned aerial vehicle (UAV)), which is equipped with an imaging device to capture images while flying along a predetermined flight path. The platform can receive instructions such as flight path and imaging instructions from the base station, fly and capture images based on the instructions, and send the captured images to the base station. When shooting the object to be imaged, the platform can fly along the set fixed path and tilt the imaging device on the platform to capture images based on a positional relationship between the platform and the object to be imaged.

### SUMMARY

One aspect of the present disclosure provides an information processing device for generating imaging control information for imaging an object by a moving body. The information processing device includes a processing unit configured to obtain shape information of the object to be imaged; generate a moving path for imaging a side of the object to be imaged based on an imaging distance corresponding to the shape information; set an imaging position on the moving path; and set an imaging direction at the imaging position based on a normal direction of the side of the object to be imaged.

Another aspect of the present disclosure provides an imaging control method of an information processing device for generating imaging control information for imaging an object to be imaged through a moving body. The method includes obtaining shape information of the object to be imaged; generating a moving path for imaging a side of the object to be imaged based on an imaging distance corresponding to the shape information; setting an imaging position on the moving path; and setting an imaging direction at the imaging position based on a normal direction of the side of the object to be imaged.

### BRIEF DESCRIPTION OF THE DRAWINGS

FIG. 1 is a schematic diagram illustrating a first configuration example of a flying object system according to an embodiment of the present disclosure.

FIG. 2 is a schematic diagram illustrating a second configuration example of the flying object system according to an embodiment of the present disclosure.

FIG. 3 is a schematic diagram of an example of a specific appearance of a UAV according to an embodiment of the present disclosure.

FIG. 4 is a block diagram of an example of a hardware configuration of the UAV according to an embodiment of the present disclosure.

FIG. 5 is a block diagram of an example of a hardware configuration of a terminal according to an embodiment of the present disclosure.

FIG. 6 is a diagram of an example of a flight path of a UAV according to an embodiment of the present disclosure.

FIG. 7 is a diagram for explaining a first example of a setting example of a flight path on a horizontal plane at a predetermined height according to an embodiment of the present disclosure.

FIG. 8 is a diagram for explaining a second example of a setting example of a flight path on a horizontal plane at a predetermined height according to an embodiment of the present disclosure.

FIG. 9 is a diagram for explaining a setting example of an imaging position on a flight path at a predetermined height according to an embodiment of the present disclosure.

FIG. 10 is a diagram for explaining a calculation example of an imaging direction at an imaging position on the flight path according to an embodiment of the present disclosure.

FIG. 11 is a flowchart of a first example of an imaging control operation according to an embodiment of the present disclosure.

FIG. 12 is a flowchart of a second example of the imaging control operation according to an embodiment of the present disclosure.

REFERENCE NUMERALS

| | |
|---|---|
| 10 | Flying object system |
| 80 | Terminal |
| 81 | Terminal controller |
| 83 | Operation unit |
| 85 | Communication unit |
| 87 | Memory |
| 88 | Display unit |
| 89 | Memory |
| 100 | UAV |
| 110 | UAV controller |
| 150 | Communication interface |
| 160 | Memory |
| 170 | Memory |
| 200 | Gimbal |
| 210 | Rotor mechanism |
| 220, 230 | Imaging device |
| 240 | GPS receiver |
| 250 | Inertial measurement unit |
| 260 | Magnetic compass |
| 270 | Barometric altimeter |
| 280 | Ultrasonic sensor |
| 290 | Laser measuring instrument |

### DETAILED DESCRIPTION OF THE EMBODIMENTS

The technical solutions provided in the embodiments of the present disclosure will be described below with reference to the drawings. However, it should be understood that the following embodiments do not limit the disclosure. It will be appreciated that the described embodiments are some rather than all of the embodiments of the present disclosure. Other embodiments conceived by those having ordinary skills in the art on the basis of the described embodiments without inventive efforts should fall within the scope of the present disclosure. It should be noted that technical solutions provided in the present disclosure do not require all combinations of the features described in the embodiments of the present disclosure.

The information processing device provided in the present disclosure may be a computer included in at least one of a flying object as an example of a moving object and a platform for remotely controlling the operating or processing of the flying object, and performing various processing related to the operation of the flying object. The moving objects involved in the present disclosure are not limited to flying objects, but may include vehicles, ships, and other moving objects.

The imaging control method provided in the present disclosure may be used to specify various processing (or steps) in an information processing device (e.g., a platform or a moving object).

The program provided in the present disclosure may be a program for causing an information processing device (e.g., a platform or a moving object) to execute various processing (or steps).

The recording medium provided in the present disclosure may record a program (i.e., a program for causing an information processing device (e.g., a platform or a moving object) to execute various processing (or steps)).

The flying objects may include aircrafts that move in the air (e.g., UAVs or helicopters). The flying object may be a UAV with an imaging device. To photograph an object to be imaged within the imaging range (e.g., the ground shape of buildings, roads, parks, etc. within a certain range), the flying object may fly along a predetermined flight path as a moving path, and capture images of the object to be imaged at multiple imaging positions set on the flight path. The object to be imaged may include, for example, objects such as buildings and roads.

The platform may be a computer, for example, a transmitter for instructing remote control of various processes including the movement of the flying object, or a communication terminal connected to the transmitter or the flying object to facilitate the input and output of information and data. The communication terminal may be, for example, a portable terminal, a PC, or the like. In addition, the flying object itself may be included as a platform.

Often, the three-dimensional (3D) shape of an object such as a building is estimated based on the captured images, such as the aerial images captured by a UAV flying in the air. To automate the video shooting of the UAV (i.e., aerial photography), the technology of generating the flight path of the UAV in advance can be used. Therefore, to use the UAV to estimate the 3D shape of an object such as a building, the UAV needs to fly based on a predetermined flight path, and obtain multiple images of the object to be imaged by the UAV at different imaging positions in the flight path.

Although video shooting can be performed while passing through a fixed path, the existence of an object (such as a building) in the vertical direction from the fixed path is not fully considered. It is difficult to sufficiently capture an image of the side of the object, and an image of another part of the object hidden in a part of the object when observed from above.

In addition, when shooting the side of a specially designed object through a UAV, the flight path of the UAV can be manually determined in advance. When specifying the desired locations around the object as the shooing locations, the user can specify the locations (latitude, longitude, and altitude) in the 3D space. In this case, since each shooing location is determined by user input, the convenience of the user is reduced. Moreover, in order to determine the flight path, detailed information about the object is needed in advance, which make the preparation of the flight path more troublesome. In addition, when determining the flight path, a fixed flight path that circulates around the side of the object can be considered. In this case, if the object is captured while flying with a fixed flight radius and a fixed flight center, it is possible that the captured image in an appropriate sate (e.g., the desired imaging distance, the desired imaging direction, and the desired resolution) cannot be obtained. In addition, when the imaging distance is set relatively short, if there is a protrusion on the side of the object, the UAV may collide with the object.

In the following embodiments, a UAV is being used as an example of the flying object as an example of the moving object. In the accompanying drawings, the unmanned aircraft is also marked as UAV. In the embodiments of the present disclosure, the information processing device may set a flight path as an example of a moving path including an imaging position, where the side of the object can be photographed by the flying object. In addition, when the moving object is a vehicle or the like, the moving path may be set within the moving range of the ground, roads, etc. The information processing device may be a terminal, but it may also be other devices (e.g., a transmitter, a server, a UAV).

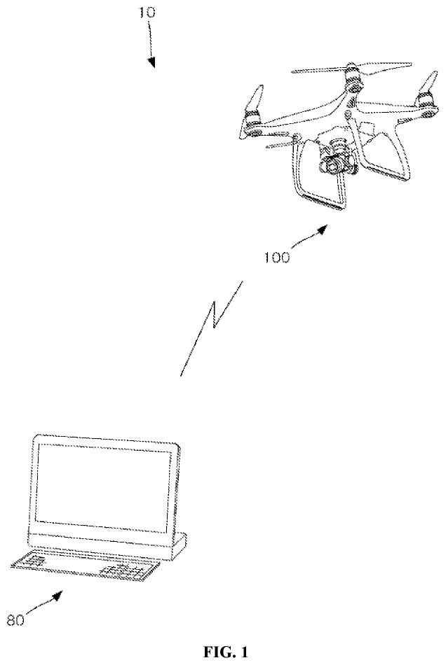

FIG. 1 is a schematic diagram of a first configuration example of a flying object system 10 according to an embodiment of the present disclosure. The flying object system 10 includes a UAV 100 and a terminal 80. The UAV 100 and the terminal 80 may communicate with each other through wired communication or wireless communication (e.g., a wireless local area network (LAN)). In FIG. 1, the terminal 80 is illustrated as a PC.

In addition, the composition of the flying object system may include a UAV, a transmitter, and a portable terminal. When the transmitter is included, the person who uses the flying object system (hereinafter referred to as the user) can use the left and right joysticks disposed on the front of the transmitter to instruct the control to control the flight of the UAV. In addition, in this case, the UAV, the transmitter, and the portable terminal may communicate with each other through wired communication or wireless communication.

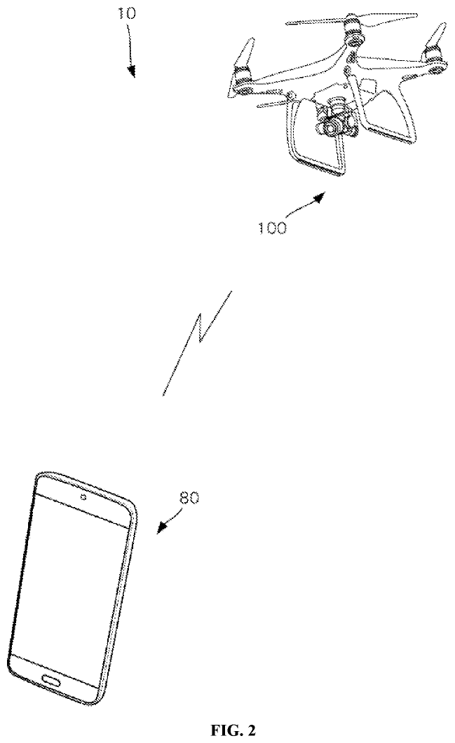

FIG. 2 is a schematic diagram of a second configuration example of the flying object system 10 according to an embodiment of the present disclosure. In FIG. 2, the terminal 80 is illustrated as a portable terminal (e.g., a smart phone, a tablet terminal). In any one of the configuration examples of FIG. 1 and FIG. 2, the functions of the terminal 80 may be the same.

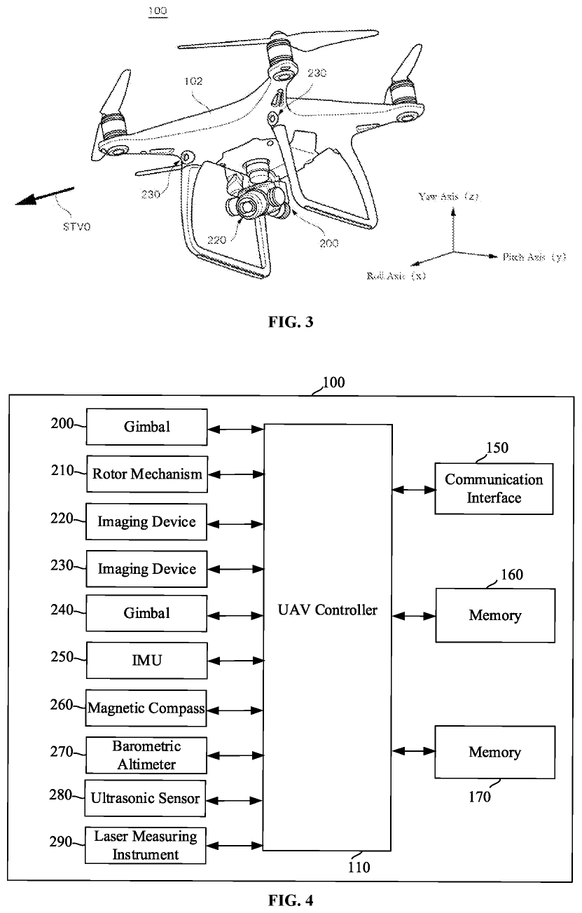

FIG. 3 is a diagram of an example of a specific appearance of the UAV 100. FIG. 3 illustrates a perspective view of the UAV 100 when it moves in a moving direction STV0.

As shown in FIG. 3, the direction parallel to the ground and along the moving direction STV0 is defined as the roll axis (which can be referred to as the x-axis). In this case, the direction parallel to the ground and perpendicular to the roll axis is defined as the pitch axis (which can be referred to as the y-axis), and the direction perpendicular to the ground and perpendicular to the roll axis and the pitch axis is defined as the yaw axis (which can be referred to as the z-axis).

The UAV 100 is composed of a UAV main body 120, a gimbal 200, an imaging device 220, and a plurality of imaging devices 230. The UAV 100 is an example of a moving object that includes the imaging devices 220 and 230 that can move. The movement of the UAV 100 may refer to the flight, which may include at least the ascent, descent, left rotation, right rotation, left horizontal movement, and right horizontal movement.

The UAV main body 120 may include a plurality of rotors (propellers). The UAV main body 120 may cause the UAV 100 to fly by controlling the rotation of the plurality of rotors. The UAV main body 120 may use, for example, four rotors to fly the UAV 100. The number of rotors is not limited to four. In addition, the UAV 100 may also be a fixed-wing aircraft without a rotor.

The imaging device 220 may be an imaging camera that can capture an object to be imaged (e.g., a building on the ground) included in a desired imaging range. In addition, other than the objects such as buildings, the object to be imaged may also include scenes in the sky, mountains, rivers, etc., which can be the aerial photography targets of the UAV 100.

The plurality of imaging devices 230 may be sensing cameras that can capture images of the surroundings of the UAV 100 in order to control the flight of the UAV 100. Two imaging devices 230 may be disposed on the nose of the UAV 100, that is, the front. In addition, two imaging devices 230 may be disposed on the bottom surface of the UAV 100. The two imaging devices 230 on the front side may be paired to function as a stereo camera. The two imaging devices 230 on the bottom side may also be pairs to function as a stereo camera. The 3D spatial data (3D shape data) around the UAV 100 can be generated based on the images captured by the plurality of imaging devices 230. In addition, the number of imaging devices 230 included in the UAV 100 is not limited to four. The UAV 100 may only need to include at least one imaging devices 230. The UAV 100 may include one of more imaging devices 230 on the nose, tail, sides, bottom surface, and top surface of the UAV 100, respectively. The angle of view of the imaging device 230 may be set to be larger than the angle of view of the imaging device 220. The imaging device 230 may have a single focus lens or a fisheye lens.

FIG. 4 is a block diagram of an example of a hardware configuration of the UAV 100. The UAV 100 is composed of a UAV controller 110, a communication interface 150, a memory 160, a memory 170, a gimbal 200, a rotor mechanism 210, a imaging device 220, a imaging device 230, a GPS receiver 240, a inertial measurement unit (IMU) 250, a magnetic compass 260, a barometric altimeter 270, an ultrasonic sensor 280, and a laser measuring instrument 290.

In some embodiments, the UAV controller 110 may be composed of a processor, such as a central processing unit (CPU), a micro processing unit (MPU), or a digital signal processor (DSP). The UAV controller 110 may be configured to perform signal processing for the overall control of the operation of each part of the UAV 100, the data input and output processing with other parts, the data arithmetic processing, and the data storage processing.

In some embodiments, the UAV 100 may control the movement (i.e., flight) of the UAV 100 based on a program stored in the memory 160. The UAV controller 110 may control the flight of the UAV 100 based on the instructions received from a remote transmitter or via the communication interface 150.

In some embodiments, the UAV controller 110 may be configured to obtain image data (hereinafter referred to as the captured image) of an object to be imaged by the imaging device 220 and the imaging device 230. The UAV controller 110 may be configured to perform aerial photography through the imaging device 220 and the imaging device 230, and obtain the aerial images as the captured images.

In some embodiments, the communication interface 150 may communicate with the terminal 80. The communication interface 150 is an example of a communication unit. The communication interface 150 may be configured to perform wireless communication by any wireless communication method. The communication interface 150 may be configured to perform wired communication through any wired communication method. The communication interface 150 may transmit the captured images and additional information (metadata) related to the captured images to the terminal 80. The communication interface 150 may be configured to obtain flight control instruction information from the terminal 80. The flight control instruction information may include information such as a flight path used for the UAV 100 to fly, flight positions (e.g., waypoints) used to generate the flight path, and control points that can be used as the basis to generate the flight path.

In some embodiments, the memory 160 may be an example of a storage unit. The memory 160 may store the program that the UAV controller 110 needed to control the gimbal 200, the rotor mechanism 210, the imaging device 220, the imaging device 230, the GPS receiver 240, the IMU 250, the magnetic compass 260, the barometric altimeter 270, the ultrasonic sensor 280, and the laser measuring instrument 290. The memory 160 may be a computer-readable recording medium, and may include at least one of the flash memory such as a static random access memory (SRAM), a dynamic random access memory (DRAM), an electrically erasable programmable read-only memory, and a universal serial bus (USB) memory. The memory 160 may be disposed inside the UAV main body 120. The memory 160 may be detached from the UAV 100. The memory 160 may record the captured images taken by the imaging device 220 and the imaging device 230. The memory 160 may be used as a working memory.

In some embodiments, the memory 170 may be an example of a storage unit. The memory 170 may store and save various data and various information. The memory 170 may include at least one of a hard disk drive (HDD), a solid state drive (SSD), a SD memory card, a USB memory, and other storage devices. The memory 170 may be disposed inside the UAV main body 120. The memory 170 may be detached from the UAV 100, and the memory 170 may record the captured images.

In some embodiments, the gimbal 200 may rotate around at least one axis and may rotatably support the imaging device 220. In some embodiments, the gimbal 200 may rotatably support the imaging device 220 using the yaw axis, the pitch axis, and the roll axis as centers. In some embodiments, the gimbal 200 may cause the imaging device 220 to rotate based on at least one of the yaw axis, the pitch axis, and the roll axis as a center, to change the imaging direction of the imaging device 220.

In some embodiments, the rotor mechanism 210 may include a plurality of rotors and a plurality of drive motors that can rotate the plurality of rotors. The rotation of the rotor mechanism 210 can be controlled by the UAV controller 110 to cause the UAV 100 to fly.

In some embodiments, the imaging device 220 may capture images of an object to be imaged within an expected imaging range and generate data of the captured images. The image data (e.g., the aerial images) obtained through imaging by the imaging device 220 may be stored in the storage device 160 or the memory 170 of the imaging device 220.

In some embodiments, the imaging device 230 may capture the surroundings of the UAV 100 and generate data of the captured images. The image data of the imaging device 230 may be stored in the memory 160 or the memory 170.

In some embodiments, the GPS receiver 240 may receive multiple signals transmitted by multiple navigation satellites (e.g., GPS satellites), which indicate the time and location (e.g., coordinates) of each GPS satellite. The GPS receiver 240 may calculate the location of the GPS receiver 240 (i.e., the location of the UAV 100) based on the multiple received signals. The GPS receiver 240 may output location information of the UAV 100 to the UAV controller 110. In addition, the UAV 110 may replace the GPS receiver 240 to calculate the location information of the GPS receiver 240. The information indicating the time and location of each GPS satellite included in the multiple signals received by the GPS receiver 240 may be input into the UAV controller 110.

In some embodiments, the IMU 250 may detect the attitude of the UAV 100, and may output the detection result to the UAV controller 110. The IMU 250 may detect the accelerations in three axes directions: front-rear, left-right, and up-down, and the angular velocities in three axes directions: the pitch axis, the roll axis, and the yaw axis, as the attitude of the UAV 100.

In some embodiments, the magnetic compass 260 may detect an orientation of the head of the UAV 100, and may output the detection result to the UAV controller 110.

In some embodiments, the barometer 270 may detect the flight altitude of the UAV 100, and may output the detection result to the UAV controller 110.

In some embodiments, the ultrasonic sensor 280 may transmit an ultrasound wave, detect the ultrasound wave reflected by the ground and object, and may output the detection result to the UAV controller 110. The detection result may indicate the distance from the UAV 100 to the ground, i.e., the altitude. The detection result may indicate the distance from the UAV 100 to the object.

In some embodiments, the laser measurement device 290 may emit a laser beam to an object, and receive a reflected laser beam from the object. The laser measurement device 290 may measure the distance between the UAV 100 and the object (e.g., the object to be imaged) based on the reflected laser beam. The distance measurement result can be sent to the UAV controller 110. An example of the laser based distance measurement method includes a flight of time method.

Next, an example of the function of the UAV controller 110 of the UAV 100 will be described in detail.

The UAV control unit 110 may obtain position information indicating the position of the UAV 100. The UAV control unit 110 may obtain, from the GPS receiver 240, position information indicating the latitude, longitude and altitude where the UAV 100 is located. The UAV control unit 110 may acquire, from the GPS receiver 240, latitude and longitude information indicating the latitude and longitude where the UAV 100 is located, and may obtain, from the pressure altimeter 270, altitude information indicating the altitude where the UAV 100 is located, which information acts as the position information. The UAV controller 110 may also obtain the distance between the radiation point of the ultrasonic wave generated by the ultrasonic sensor 280 and the reflection point of the ultrasonic wave as altitude information.

The UAV control unit 110 may obtain, from the magnetic compass 260, orientation information indicating the orientation of the UAV 100. For example, an orientation corresponding to the orientation of the nose of the unmanned aerial vehicle 100 is indicated in the orientation information.

The UAV controller 110 may capture the object to be imaged in a horizontal direction, a predetermined angular direction, or a vertical direction through the imaging positions (included in the waypoints) set in the flight path through the imaging device 220 or the imaging device 230. The predetermined angular direction may be an angular direction of a predetermined value suitable for the information processing device (the UAV or the platform) to estimate the 3D shape of the object to be imaged.

The UAV controller 110 may obtain the position information indicating the position where the UAV 100 should be when the imaging device 220 captures the imaging range that should be captured. The UAV controller 110 may obtain the position information indicating the position where the UAV controller 110 should be from the memory 160. The UAV controller 110 may acquire the position information indicating the positon where the UAV 100 should be from another device via the communication interface 150. To capture the imaging range that should be captured, the UAV controller 110 may refer to a 3D map database to specify the position where the UAV controller 110 should be, and obtain the position as the position information indicating the positon where the UAV 100 should be.

The UAV control unit 110 may obtain the image range information indicating imaging ranges of the imaging device 220 and the imaging device 230. The UAV control unit 110 may obtain, from the imaging device 220 and the imaging device 230, the angle of view information indicating the angles of view of the imaging device 220 and the imaging device 230, the information can be used as a parameter for specifying the imaging ranges. The UAV control unit 110 may obtain information indicating the imaging directions of the imaging device 220 and the imaging device 230, the information can be used as a parameter for specifying the imaging ranges. The UAV control unit 110 may obtain, from the gimbal 200, attitude information indicating the state of attitude of the imaging device 220, the information can be used as the information indicating the imaging direction of the imaging device 220. For example, the attitude information of the imaging device 220 can be expressed in terms of the angle at which the pitch axis and the yaw axis of the gimbal 200 rotate from a reference rotation angle. The UAV control unit 110 may obtain information indicating the orientation of the unmanned aerial vehicle 100, the information can be used as the imaging direction information of the imaging device 220.

The UAV control unit 110 may obtain the position information indicating the position of the UAV 100 as a parameter for specifying the imaging range. The UAV control unit 110 may define the imaging range representing the geographic range captured by the imaging device 220 based on the angles of view and the imaging directions of the imaging device 220 and the imaging device 230, and the position of the UAV 100, and generate the imaging range information, thereby obtaining the imaging range information.

The UAV controller 110 may obtain the imaging range information from the memory 160/The UAV controller 110 may also obtain the imaging range information via the communication interface 150.

The UAV controller 110 may be configured to control the gimbal 200, the rotor mechanism 210, the imaging device 220, and the imaging device 230. The UAV controller 110 may control the imaging range of the imaging device 220 by changing the imaging direction or the angle of view of the imaging device 220. The UAV controller 110 may control the imaging range of the imaging device 220 supported by the gimbal 200 by controlling the rotation mechanism of the gimbal 200.

The imaging range refers to a geographical range captured by the imaging device 220 or the imaging device 230. The imaging range may be defined by latitude, longitude, and altitude. The imaging range may be a range of 3D spatial data defined by latitude, longitude, and altitude. The imaging range may be a range of 2D spatial data defined by latitude and longitude. The imaging range may be specified based on the angle of view and the imaging direction of the imaging device 220 or the imaging device 230, and the position where the UAV 100 is located. The imaging direction of the imaging device 220 or the imaging device 230 may be defined by the frontal orientation and the pitch angle of the imaging lens of the imaging device 220 and the imaging device 230. The imaging direction of the imaging device 220 may be a direction specified based on the orientation of the nose of the UAV 100 and the attitude state of the imaging device 220 with respect to the gimbal 200. The imaging direction of the imaging device 230 may be a direction specified based on the orientation of the nose of the UAV 100 and the position where the imaging device 230 is positioned.

The UAV controller 110 may specify the surrounding environment of the UAV 100 by analyzing a plurality of images captured by the plurality of imaging devices 230. The UAV controller 110 may control the flight based on the surrounding environment of the UAV 100, such as avoiding obstacles. The UAV controller 110 may generate 3D spatial data around the UAV 100 based on the plurality of images captured by the plurality of imaging devices 230, and may control the flight based on the 3D spatial data.

The UAV controller 110 may obtain 3D information indicating the 3D shape of an object around the UAV 100. For example, the object may be a part of a landscape such as buildings, roads, vehicles, trees, etc. The stereo information may be 3D spatial data. The UAV controller 110 may obtain the stereo information from each image captured by the plurality of imaging devices 230 by generating the stereo information indicating the stereo shape of the object around the UAV 100. The UAV controller 110 may obtain the 3D information indicating the 3D shape of the object around the UAV 100 by referring to a 3D map database stored in the memory 160 or the memory 170. The UAV controller 110 may obtain the 3D information related to the 3D shape of the objet around the UAV 100 by referring to a 3D map database managed by a server in a network.

The UAV controller 110 may control the flight of the UAV 100 by controlling the rotor mechanism 210. That is, the UAV controller 110 may control the position, including the latitude, longitude, and altitude of the UAV 100 by controlling the rotor mechanism 210. The UAV controller 110 may control the imaging range of the imaging device 220 and the imaging device 230 by controlling the flight of the UAV 100. The UAV controller 110 may control the angle of view of the imaging device 220 by controlling the zoom lens included in the imaging device 220. The UAV controller 110 may use the digital zoom function of the imaging device 220 to control the angle of view of the imaging device 220 through digital zooming.

When the imaging device 220 is fixed to the UAV 100 and the imaging device 220 cannot be moved, the UAV controller 110 may move the imaging device 220 to a specified position by moving the UAV 100 to the specified position on a specified date and time, such that the imaging device 220 can capture the desired imaging range in the desired environment. Alternatively, even when the imaging device 220 does not have a zoom function and the angle of view of the imaging device 220 cannot be changed, the UAV controller 110 may move the/110 to the specified positon on the specified date and time, such that the imaging device 220 can capture the desired imaging range in the desired environment.

The UAV controller 110 may obtain date and time information indicating the current date and time. The UAV controller 110 may obtain the date and time information indicating the current date and time from the GPS receiver 240. The UAV controller 110 may obtain the date and time information indicating the current date and time from a time (not shown in FIG. 4) mounted on the UAV 100.

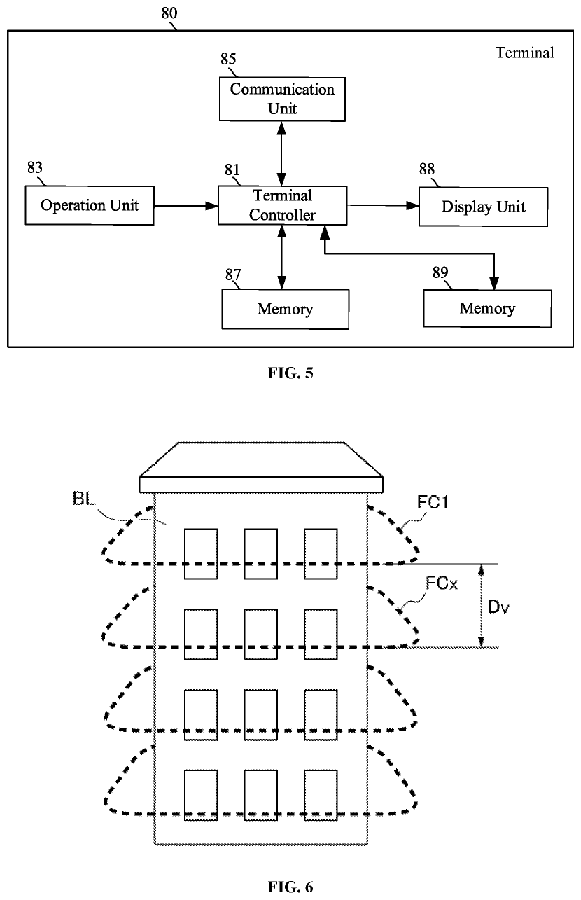

FIG. 5 is a block diagram of an example of a hardware configuration of a terminal 80 according to an embodiment of the present disclosure. The terminal 80 includes a terminal controller 81, an operation unit 83, a communication unit 85, a memory 87, a display unit 88, and a memory 89. The terminal 80 may be held by a user who wants to instruct the flight control of the UAV 100. The terminal 80 may be an example of the information processing device, and the terminal controller 81 may be an example of a processing unit of the information processing device.

The terminal controller 81 may be composed of a CPU, an MPU or a DSP. The terminal controller 81 may be configured to perform signal processing for the overall control of the operation of each part of the terminal 80, the data input and output processing with other parts, the data arithmetic processing, and the data storage processing.

The terminal controller 81 may obtain data and information from the UAV 100 via the wireless communication unit 85. The terminal controller 81 may also obtain data and information from the operation unit 83. The terminal controller 81 may also obtain data and information stored in the memory 87. The terminal controller 81 may transmit data and information to the UAV 100 via the communication unit 85. The terminal controller 81 may also transmit data and information to the display unit 88, and cause the display unit 88 to display the display information based on the data and information. The terminal controller 81 may transmit data and information to the memory 89 and store the data and information. The terminal controller 81 may obtain data and information stored in the memory 89. The information output from the terminal controller 81 and displayed by the display unit 88, and the information sent to the UAV 100 through the communication unit 85 may include information such as the flight path used for the flight of the UAV 100, the flight positions (waypoints) used to generate the flight path, the imaging positions where the object to be imaged can be captured, and the control points for generating the flight path.

The terminal controller 81 may execute an application program for instructing the control of the UAV 100. The terminal controller 81 may also execute an application program for generating the flight path of the UAV 100. The terminal controller 81 may also generate various data used in the application program.

The operation unit 83 may receive and obtain data and information input by a user of the terminal 80. The operation unit 83 may include input devices such as buttons, keys, a touch panel, and a microphone. Herein, the operation unit 83 and the display unit 88 being configured by the touch panel is being used as an example. In this case, the operation unit 83 can receive a touch operation, a tap operation, a drag operation, or the like.

The wireless communication unit 85 may communicate with the UAV 100 and through various wireless communication methods. The wireless communication methods may include, for example, communication via wireless LAN, Bluetooth (a registered trademark), short-range wireless communication, or a public wireless line. The communication unit 85 may also perform wired communication by any wired communication method. The communication unit 85 may transmit and receive data and information by communicating with other devices.

The memory 87 may be an example of a storage unit. The memory 87 may include, for example, a program that defines the operation of the terminal 80, a ROM that stored data of setting values, and a RAM that temporarily stores various pieces of information and data used when the terminal controller 81 performs processing. The memory 87 may include a memory other than the ROM and the RAM. The memory 87 may be provided in the terminal 80. The memory 87 may be configured to be detachable from the terminal 80. The program may include an application program.

The display unit 88 may be composed of, for example, a liquid crystal display (LCD) or an electro-luminescence (EL) display, and display various pieces of information and data output from the terminal controller 81. The display unit 88 may display various pieces of data and information related the execution of the application program. The display unit 88 may display the data of the captured images taken by the imaging device 220 and the imaging device 230 of the UAV 100.

The memory 89 may be an example of a storage unit. The memory 89 may store various pieces of data and information. The memory 89 may include at least on of HDD, SS, memory card, USB memory, and other memories. The memory 89 may be disposed inside the terminal 80. The memory 89 may record images and additional information obtained from the UAV 100. Additional information can be stored in the memory 87.

In addition, when the flying object system 10 includes a transmitter (e.g., a proportional controller), the processing performed by the terminal 80 may also be performed by the transmitter. Since the transmitter may include the same components of the terminal 80, detailed description will be omitted. The transmitter may include a controller, an operation unit, a communication unit, a display unit, and a memory. When the flying object system 10 includes the transmitter, the terminal 80 may not be provided.

As a function of the terminal controller 81 of the terminal 80, a function related to the generation of a flight path will be described below. The terminal controller 81 may perform the setting of a flight path corresponding to an object having a complex shape by performing processing related to the generate of a flight path including an imaging position capable of capturing the side surface of the object.

FIG. 6 is a diagram of an example of a flight path of the UAV 100. In this embodiment, it is assumed that an object having a height in the vertical direction, such as a building, is used as an object to be imaged BL, and the example illustrates the setting of a flight path in which the UAV 100 can fly around the object to be imaged BL and photograph the side of the object to be imaged BL. At this time, the UAV 100 may be facing the horizontal direction (i.e., the normal direction of the vertical direction) and photographing the sides of the object to be imaged BL from the side. The terminal controller 81 may input and obtain information such as the flight range, the flight altitude, the imaging range of the captured image, and the imaging resolution as the parameters related to the setting of the flight path. The terminal controller 81 may also obtain the initial imaging range, altitude, position, imaging distance, interval between the imaging positions, the angle of view of the imaging device, the overlap ratio of the imaging range, etc. In addition, the terminal controller 81 may obtain the shape information of the object of the object to be imaged BL. The terminal controller 81 may receive and obtain the identification information of the object to be imaged. The terminal controller 81 may communicate with an external server via the communication unit based on the identification information of the specified object, and receive and obtain the shape information and size of the object corresponding to the identification information of the object. The shape information of the object to be imaged may be obtained through the 3D map databased stored in the terminal 80, a server, or other devices. The 3D shape data of the outer shape may be obtained from the 3D information (e.g., the polygon data) such as buildings and roads included in the map information of the 3D map database.

As an example of a method of setting the flight path, the height of the terminal controller 81 in the vertical direction with respect to the object to be imaged BL, for example, a flight path flying in a substantially horizontal direction the captures the highest altitude imaging range, may be set as an initial flight path (the first flight path) FC1. The initial flight path FC1 may be a flight path set to circle around the highest part of the object to be imaged BL. The flight path may include multiple flight paths with different heights (i.e., imaging heights). The flight path may be formed with the sky side as the starting point, and the altitude may decrease as the flight path advances. The terminal controller 81 may set the next flight path (e.g., a second flight path) FCx, which may be spaced apart in the vertical direction of the object to be imaged BL, and may change the height at each vertical imaging interval Dv. Here, the terminal controller 81 may set the vertical imaging interval Dv in the vertical direction of the object to be imaged BL based on a predetermined imaging resolution set by the input parameter or the like. The terminal controller 81 may input the predetermined vertical imaging interval Dv based on the vertical angle of view, the imaging resolution, and the like of the imaging device of the UAV 100. Each flight path may be a flight path of the UAV 100 in the horizontal direction around the object to be imaged BL (i.e., the flight height barely changes). The height of each flight path may be arranged such that the imaging range of the captured images at the imaging position of the adjacent flight path in the vertical direction may partially overlap. In this way, as the flight path of the UAV 100, that is, the horizontal flight paths FC1, FCx . . . of different heights from the top to the bottom of the side of the object to be imaged BL, can be set such that the UAV 100 can fly based on the flight path and capture images while circling around the object to be imaged BL. In addition, the flight path of the UAV 100 may also be formed from the ground side as the starting point, and the height may increase as the flight path advances. The order of the initial flight path FC1 and other flight paths FCx, and the order of the flight height can be set arbitrarily. For example, the flight may start from a height lower than the object to be imaged BL.

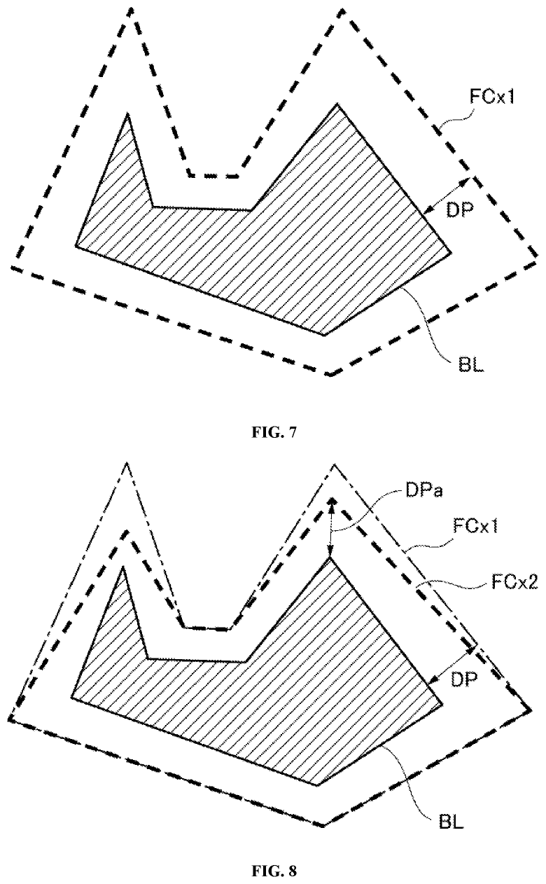

FIG. 7 is a diagram for explaining a first example of a setting example of a flight path on a horizontal plane at a predetermined height as an example of a movement path. FIG. 7 illustrates a cross section of the outer shape of the object to be imaged BL at a predetermined height. As a first example of the flight path setting method, the terminal controller 81 may obtain the outer shape of the object to be imaged BL, calculate an outer path spaced apart from the outer shape by a predetermined imaging distance DP, and set the outer path as the flight path FCx1. Here, the terminal controller 81 may set the imaging distance DP based on a predetermined imaging resolution set by the input parameters or the like. The terminal controller 81 may input the predetermined imaging distance DP. In some embodiments, the outer shape data of the object to be imaged BL may include polygon data. Based on the shape data of the object to be imaged BL, the outer path may be calculated by the polygon offset methods (polygon expansion methods), such as the pair-wise offset method and the polygon offsetting by computing winding numbers.

FIG. 8 is a diagram for explaining a second example of a setting example of a flight path on a horizontal plane at a predetermined height as an example of a movement path. The second example is a modification of the first example, and illustrate a calculation example of a flight path with a suitable imaging distance based on the outer shape of the object to be imaged BL. As the second example of setting the flight path, the terminal controller 81 may obtain the outer shape of the object to be imaged BL, calculate the imaging distance DPa corresponding to the outer shape based on the predetermined imaging distance DP, calculate the outer path having the imaging distance DPa, and set the outer path as the flight path FCx2. In the flight path FCx2 of the second example, compared to the flight path FCx1 of the first example, the imaging distance is set to be shorter at the protrusion parts of the outer shape of the object to be imaged BL.

In the second example, based on an inner angle θia of the polygonal vertex in the outer shape data of the object to be imaged BL, the imaging distance DPa can be calculated based on the formula (1) below.

$$\begin{matrix}DPa = DP * ( \frac{1}{2} + \frac{θ ia}{240} ) , & θ ia < 120 \\ DPa = DP , & θ ia \geq 120\end{matrix} \qquad ( 1 )$$

In formula (1), DP represents the predetermined imaging distance, θia represents the inner angle of the polygonal vertex in the shape data of the object to be imaged BL, and * represents the multiplication operator. In this case, when the inner angle θia is less than 120°, the imaging distance DPa may be shorter than the predetermined imaging distance DP, and a value corresponding to the size of the inner angle θia may be taken in the range of (½)DP to DP. That is, when the inner angle or the curvature of the polygonal vertex of the outer shape is relative small, the imaging distance DPa may be a relative short distance.

In addition, the curvature of the curve in the outer shape data can be used instead of the inner angle θia of the polygonal vertex in the outer shape data, and the imaging distance can be calculated similarly based on the curvature.

Next, as functions of the terminal controller 81 of the terminal 80, functions related to the generation of the imaging control information will be described. The terminal controller 81 can perform the imaging control corresponding to an object have a complex shape by executing processing related to the generation of the imaging control information. The imaging control information may indicate the imaging position and the imaging direction on the flight path for imaging the side of the object.

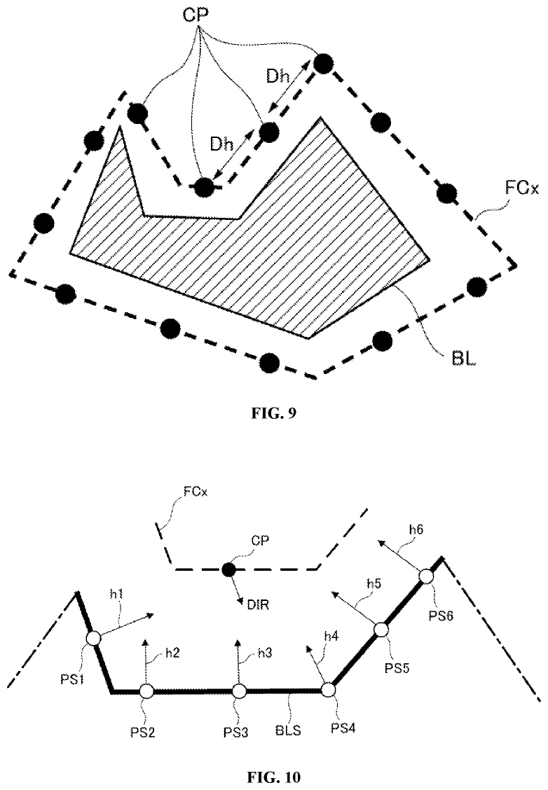

FIG. 9 is a diagram for explaining a setting example of an imaging position on a flight path at a predetermined height. As an example of the imaging position setting method, the terminal controller 81 may be configured to calculate the points obtained by dividing the flight path at each horizontal imaging interval Dh on the flight path FCx set relative to the outer shape of the object to be imaged BL in the horizontal direction at intervals of the horizontal imaging interval Dh, and set each point as the imaging position CP. Here, the terminal controller 81 may set the horizontal imaging interval Dh in the horizontal direction of the object to be imaged BL based on a predetermined imaging resolution set by the input parameters or the like. The terminal controller 81 may input a predetermined horizontal imaging interval Dh based on the horizontal angle of view, the imaging resolution, and the like of the imaging device of the UAV 100. When setting the imaging position CP, the terminal controller 81 may determine and arrange an initial imaging position CP on a flight path FCx and use the initial imaging position CP as a base point, and arrange the imaging positions CP on the flight path FCx at equal intervals in order at each horizontal imaging interval Dh. In a flight path, the first imaging position and the last imaging position may be a distance shorter than the horizontal imaging interval Dh. The horizontal imaging interval Dh may be a variable value, for example, a different value may be set based on the outer shape of the object to be imaged BL.

The imaging position interval may be an imaging interval in space, and may be the distance between adjacent imaging positions in a plurality of imaging positions where the UAV 100 should capture an image in the flight path. The terminal controller 81 may arrange the imaging positions for the imaging device 220 or the imaging device 230 to capture images on the flight path. The respective imaging positions may be arranged such that the imaging ranges in the captured images at adjacent imaging positions in the flight path may partially overlap. As such, the 3D shape can be estimated by using the plurality of captured images. Since the imaging device 220 or the imaging device 230 has a predetermined angle of view, by shortening the interval between the imaging positions, the two imaging ranges may partially overlap.

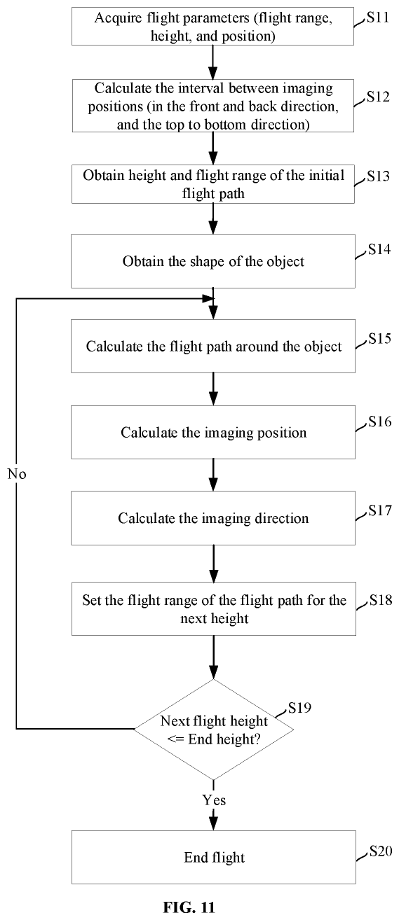

FIG. 10 is a diagram for explaining a calculation example of the imaging direction at the imaging position on the flight path. The terminal controller 81 may be configured to calculate and set an appropriate imaging direction DIR based on the normal direction of the side surface of the outer shape of the object to be imaged BL in the imaging range at each set imaging position CP. An example of the calculation method of the imaging direction DIR will be described below. First, in the horizontal plane including the imaging position CP, for the outer shape BLS of the object to be imaged BL positioned in the imaging range, considering the line of sight from the imaging position CP may be blocked, sampling may be performed at predetermined intervals. The number, position, interval, etc. of the sampling points may be set appropriately based on the imaging distance at the imaging position CP, the shape of the object to be imaged BL, etc. In the example in FIG. 10, there are 6 sampling points, and each sampling point is represented by PS1, PS2 . . . PS6, respectively. Subsequently, the normal vector h1-h6 at each sampling point PS1-PS6 can be obtained, and the angle θ1-θ6 (indicated by θn) can be calculated when a predetermined reference direction (e.g., north) is 0. Then, at each sampling point PS1-PS6, the weights w1-w6 (indicated by wn) can be calculated based on the formula (2) below.

$${w}_{n} = \frac{{e}^{- {d}_{n}}}{{\sum }_{m} {e}^{- {d}_{m}}} \qquad ( 2 )$$

In formula (2), do and dm represent the distance from each sampling point PS1-PS6 to the imaging position CP, e^{-dn} represents the negative exponential function of the distance from each sampling point to the imaging position CP, and Σe^{-dm} represents the sum of the negative exponential functions of the distances from all sampling points PS1-PS6 to the imaging position CP. In this case, for each sampling point, the shorter the distance, the greater the weight wn, and the higher the importance.

Next, the direction of the object to be imaged DIRsub which illustrates the orientation of the object to be imaged BL with respect to the imaging position CP can be calculated by using formula (3) below.

$$DIRsub = arg ( \frac{{\sum }_{n} {w}_{n} {e}^{i {θ}_{n}}}{M} ) \qquad ( 3 )$$

In formula (3), wn represents the weight of each sampling point obtained by formula (2) above, e^{iθn} represents the complex exponential function of the angle θn of the normal vector of each sampling point, and M represents the total number of sampling points (the example in FIG. 10 is 6). In this case, the direction of the object to be imaged DIRsub may be equivalent to the weighted average of the angle θn, where the angle θn may be the angle of the normal vector relative to the reference direction for each sampling point PSn of the shape BLS of the object to be imaged BL. That is, the weighted average value of the angle of the normal vector of each sampling point may be a representative value of the angle from each sampling point to the imaging position CP.

Next, the imaging direction DIR at the imaging position CP can be calculated by using formula (4) below. The imaging direction may be opposite to the direction of the object to be imaged DIRsub, and may be the direction opposite to the side of the object to be imaged BL.

DIR=DIRsub−180 (4)

By calculating the opposite direction obtained by reversing the direction of the object to be imaged DIRsub obtained from formula (3) by 180° based on formula (4), an appropriate direction when photographing the object to be imaged BL from the imaging position CP can be obtained, that is, the imaging direction DIR.

The example of the imaging direction calculation method described above illustrate a calculation example of the imaging direction on a horizontal plane, and the imaging direction can be calculated appropriately by considering other parameters based on the flight path, the imaging position, the imaging distance, and the shape of the object to be imaged. In addition, for the imaging direction in the vertical direction, it may not be limited to being set in a direction consistent with the horizontal plane, but may be appropriately set, such as setting the imaging direction to be inclined upward or downward by a predetermined angle.

The terminal controller 81 may control the flight of the UAV 100 based on the generated flight path. The terminal controller 81 may send flight control information including the generated flight path to the UAV 100, and cause the UAV 100 to fly based on the flight path. The UAV 100 may rotate around the side of the object to be imaged BL and fly along the flight path. As such, the imaging device 220 and the imaging device 230 may capture the side surface of the object to be imaged at the imaging positions in the flight path. The imaged captured by the imaging device 220 and the imaging device 230 can be stored in the memory 160 of the UAV 100 or the memory 87 of the terminal 80.

Next, a specific example of the operation of imaging control using the terminal 80 will be described. In the following example operation, processing operations corresponding to the examples of the generation methods of the flight path and the imaging control information in FIG. 6 to FIG. 10 above will be described. In this example, the terminal controller 81 of the terminal 80, which is an example of the processing unit of the information processing device, can be used to execute the processing operations.

FIG. 11 is a flowchart illustrating a first example of an imaging control operation according to an embodiment of the present disclosure. The terminal controller 81 of the terminal 80 may input and obtain information including the overall flight range, altitude, position, etc. used for photographing the object to be imaged BL as flight parameters (S11). The terminal controller 81 may calculate and obtain the overall flight range, altitude, and position based on the imaging range and the imaging resolution of the captured images of the acquired object. The flight parameters may be input to the terminal 80 through a user's input operation, or may be obtained by receiving the needed information from a server or the like on the network.

The terminal controller 81 may obtain the information of the imaging resolution, and calculate the internal of the imaging position (the front and back direction (e.g., the horizontal imaging interval Dh) and the vertical direction (e.g., the vertical imaging interval Dv)) needed for in-flight imaging based on the flight parameters (S12). Subsequently, the terminal controller 81 may obtain the altitude and flight range of the initial flight path (S13). In this example operation, based on the overall flight range used to photograph the object to be imaged BL, the height of the initial flight path may be set near the upper end of the height of the object to be imaged BL. The initial flight height may be instructed by the user's input operation to instruct the terminal controller 81, or a predetermined setting value may be obtained. Alternatively, the initial flight height may be appropriately determined based on the flight parameters, the shape of the object to be imaged BL, etc. The flight range of the initial flight path (i.e., the initial flight range) may be appropriately calculated and obtained based on the height of the initial flight path and the shape of the object to be imaged BL.

Then, the terminal controller 81 may obtain the shape data of the outer shape of the object to be imaged BL as the shape of the object to be imaged (S14). The outer shape of the object to be imaged BL can be obtained from design data such as design drawings of the object, or the shape data can be obtained by estimating the outer shape of captured images obtained by roughly photographing the side of the object in advance. The captured images may include a side captured image and a lower captured image obtained by photographing an object in a vertical downward direction in detail. The captured images of the object to be imaged BL can be captured from top to bottom to obtain the outline of the object to be imaged BL on the horizontal plane.

Next, the terminal controller 81 may calculate the flight path of a target outer periphery (the outer path, and the initial flight path FC1) at the height of the initial flight path based on the obtained outer shape of the object to be imaged BL (S15). The terminal controller 81 may calculate the flight path FCx1 of the first example or the flight path FCx2 of the second example as the flight path.

Next, the terminal controller 81 may divide the flight path based on the imaging interval (i.e., the horizontal imaging interval Dh) in the front to back direction to calculate the imaging positions CP (S16). Next, the terminal controller 81 may calculate an appropriate imaging direction DIR corresponding to the outer shape of the object to be imaged BL at each imaging position CP (S17). The terminal controller 81 may calculate the imaging direction DIR based on the formulas (2) to (4) described above.

Next, the terminal controller 81 may calculate the height of the next flight path based on the imaging interval in the up and down direction (i.e., the vertical imaging interval Dv), and set the flight range of the next flight path (S18). Next, the terminal controller 81 may determine whether the height of the next flight path is equal to or less than a predetermined end height (S19). Based on the overall flight range for photographing the object to be imaged BL, the end height may be set near the lower end of the height of the object to be imaged BL.

When the height of the next flight path is higher than the end height (S19, No), the terminal controller 81 may calculate the flight path (i.e., the outer path, flight path FCx) of the target outer periphery at the height of the next flight path (S15). Thereafter, similar, the imaging positions CP in the next flight path FCx can be calculated (S16), and the imaging direction DIR at each imaging position CP can be calculated. Then, the terminal controller 81 may also calculate the height of the next flight path, and set the flight range of the next flight path (S18). The processes at S15 to S19 can be repeated until the height of the next flight path is equal to or less than the end height. In addition, for each flight path, the shape of the object to be imaged BL near the flight height can be obtained, and the calculation of the next flight path and the calculation of the imaging position and the imaging direction on the flight path can be performed.

When the height of the next flight path is equal to or less than the end height (S19, Yes), the terminal controller 81 may set the flight path as the end point, and set the fly to end (S20). Then, the terminal controller 81 may end the processing of the imaging control operated related to the generation of the flight path and the imaging control information.

The terminal controller 81 may send the flight path and the imaging control information including the flight paths FC1 and FCx, the imaging positions CP, and the imaging direction DIR as the flight control information to the UAV 100 through the communication unit 85, and execute the flight and imaging through the UAV 100. The UAV 100 can fly along the flight paths FC1 and FCx based on the flight control information, and capture images of the object to be imaged BL in the imaging direction DIR set at each imaging position CP.

In the first example described above, before using the UAV 100 to perform imaging, the terminal controller 81 may set the flight path, the imaging positions CP, and the imaging direction DIR, generate the imaging control information, and send the flight control information including the imaging control information to the UAV 100. Then, the UAV 100 may fly over each flight path based on the flight control information and perform imaging. Therefore, appropriate flight paths, imaging positions, and imaging directions may be predetermined at all heights to perform imaging.

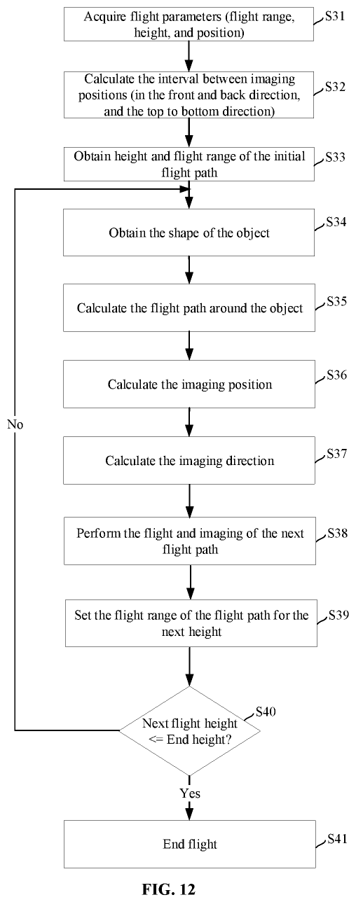

FIG. 12 is a flowchart illustrating a second example of the imaging control operation according to an embodiment of the present disclosure. The second example is a modification of the first example, and is an operation example of calculating the next flight path and the imaging positions and the imaging direction on the flight path while flying and capturing images along the flight path of each predetermined height.

As in the first example, the terminal controller 81 of the terminal 80 may input and obtain information including the overall flight range, height, position, etc. used for capturing images of the object to be imaged BL as flight parameters (S31). The terminal controller 81 may calculate and obtain the overall flight range, altitude, and position based on the imaging range and the imaging resolution of the captured images of the acquired object. The flight parameters may be input to the terminal 80 through a user's input operation, or may be obtained by receiving the needed information from a server or the like on the network.

The terminal controller 81 may obtain the information of the imaging resolution, and calculate the internal of the imaging position (the front and back direction (e.g., the horizontal imaging interval Dh) and the vertical direction (e.g., the vertical imaging interval Dv)) needed for in-flight imaging based on the flight parameters (S32). Subsequently, the terminal controller 81 may obtain the altitude and flight range of the initial flight path (S33). In this example operation, based on the overall flight range used to photograph the object to be imaged BL, the height of the initial flight path may be set near the upper end of the height of the object to be imaged BL. The initial flight height may be instructed by the user's input operation to instruct the terminal controller 81, or a predetermined setting value may be obtained. Alternatively, the initial flight height may be appropriately determined based on the flight parameters, the shape of the object to be imaged BL, etc. The flight range of the initial flight path (i.e., the initial flight range) may be appropriately calculated and obtained based on the height of the initial flight path and the shape of the object to be imaged BL.

Then, the terminal controller 81 may obtain the shape data of the outer shape of the object to be imaged BL as the shape of the object to be imaged (S34). The outer shape of the object to be imaged BL can be obtained from design data such as design drawings of the object, or the shape data can be obtained by estimating the outer shape of captured images obtained by roughly photographing the side of the object in advance.

Next, the terminal controller 81 may calculate the flight path of a target outer periphery (the outer path, and the initial flight path FC1) at the height of the initial flight path based on the obtained outer shape of the object to be imaged BL (S35). The terminal controller 81 may calculate the flight path FCx1 of the first example or the flight path FCx2 of the second example as the flight path.

Next, the terminal controller 81 may divide the flight path based on the imaging interval (i.e., the horizontal imaging interval Dh) in the front to back direction to calculate the imaging positions CP (S36). Next, the terminal controller 81 may calculate an appropriate imaging direction DIR corresponding to the outer shape of the object to be imaged BL at each imaging position CP (S37). The terminal controller 81 may calculate the imaging direction DIR based on the formulas (2) to (4) described above.

Then, the terminal controller 81 may send the flight control information including the calculated flight path (i.e., the initial flight path FC1), the imaging positions CP, and the imaging direction DIR to the UAV 100, and the UAV 100 may execute the flight of the initial flight path FC1 and capture images in the imaging direction DIR set at each imaging position CP (S38). The UAV 100 may fly along the flight path FC1 based on the flight control information, and capture images of the object to be imaged BL in the imaging direction DIR set at each imaging position CP.

Next, the terminal controller 81 may calculate the height of the next flight path based on the imaging interval in the up and down direction (i.e., the vertical imaging interval Dv), and set the flight range of the next flight path (S39). Next, the terminal controller 81 may determine whether the height of the next flight path is equal to or less than a predetermined end height (S40). Based on the overall flight range for photographing the object to be imaged BL, the end height may be set near the lower end of the height of the object to be imaged BL.

When the height of the next flight path is higher than the end height (S40, No), the terminal controller 81 may obtain the shape data of the object to be imaged BL near the flight height at the height of the next flight path (S34). Then, the terminal controller 81 may calculate the flight path (i.e., the outer path, flight path FCx) of the outer target periphery of the target at the height of the next flight path based on the obtained outer shape of the object to be imaged BL (S35). Subsequently, similarly, the imaging positions CP in the next flight path FCx can be calculated (S36), and the imaging direction DIR at each imaging position CP can be calculated (S37).

The terminal controller 81 may calculate the flight path FCx, the imaging positions CP, and the imaging direction DIR based on a plurality of captured images. The plurality of captured images mentioned above are an example of the information of the object to be imaged obtained by the next shooting of the previous flight path. The terminal controller 81 may calculate the flight path FCx, the imaging positions CP, and the imaging direction DIR based on the shape data of the outer shape of the object to be imaged BL and the like. The method of calculating and setting the flight height of the flight path is not limited to the method of using a plurality of imaging devices obtained by aerial photography of the UAV 100. For example, infrared from an infrared rangefinder (not shown in the accompanying drawings) included in the UAV 100 or a laser beam from the laser measuring instrument 290 and the GPS position information can be used as information of the object to be imaged to calculate and set the flight path for the next flight height. In addition, the terminal controller 81 may use the shape information of the object to be imaged BL initial obtained, instead of obtaining the shape of the object to be imaged BL near the flight height of each flight path, to calculate each flight path and the imaging positions and the imaging direction on the flight path.

The terminal controller 81 may send the flight path including the generated next flight path FCx, the imaging positions CP, the imaging direction DIR, and the imaging control information as the flight control information to the UAV 100 via the communication unit 85, and the UAV 100 may execute the flight of the next flight path FCx and perform imaging in the imaging direction DIR set at each imaging position CP (S38). The UAV 100 may fly along the flight path FCx based on the flight control information, and capture images of the object to be imaged BL in the imaging direction DIR set at each imaging position CP. Then, the terminal controller 81 may also calculate the height of the next flight path and set the flight range of the next flight path (S39). The processes at S35 to S40 can be repeated until the height of the next flight path is equal to or less than the end height.

When the height of the next flight path is equal to or less than the end height (S40, Yes), the terminal controller 81 may set the flight path as the end point, and set the fly to end (S41). Then, the terminal controller 81 may send the flight control information of the end of the flight to the UAV 100 via the communication unit 85, terminate the flight of the UAV 100, and end the processing of the imaging control operation.

In the second example described above, the terminal controller 81 may set the flight path, the imaging position, and the imaging direction for each flight path at a predetermined height, generate the imaging control information, and send the flight control information including the imaging control information to the UAV 100. When the UAV 100 flies along the flight path of the corresponding height based on the flight control information and perform imaging, the terminal controller 81 may set the flight path, the imaging position, and the imaging direction of the next height, and generate the imaging control information. Thus, for each flight path at each height, an appropriate flight path, imaging position, and imaging direction can be set and imaging can be performed. For example, when the object to be imaged is a building with an irregular shape, the center position or the shape of the object to be imaged can be variously changed based on the height. Even in this case, by sequentially setting the flight path based on the outer shape of the object to be imaged and performing imaging, it is possible to perform imaging of the side of the object to be imaged in the best imaging position and the imaging direction.

In addition, the UAV controller 110 of the UAV 100 may perform calculation and setting of the flight path, the imaging position, and the imaging direction in the first or second example above. The imaging control operations described in the present disclosure may be performed in the terminal 80, the UAV 100, or other devices having an information processing device.

The terminal controller 81 may obtain a plurality of captured images obtained by capturing the side of the object to be imaged BL in the flight path of each flight height through the imaging control operation of the first or second example described above, and estimate the 3D shape of the object to be imaged BL based on the plurality of captured images. The terminal controller 81 may generate the 3D information (i.e., the 3D shape data) illustrating the 3D shape of the object (e.g., the object to be imaged) based on the plurality of captured images. The captured image can be used as an image for restoring the 3D shape data. The captured image can be used to restore the 3D shape data may be a still image. As a method of generating 3D shape data based on a plurality of captured images, conventional methods can be used. The conventional methods may include the multi view stereo (MVS) method, the patch-based MVS method (PMVS), and the structured from motion (SfM) method. The processing involved in the estimation of the 3D shape of the object to be imaged BL can be performed after the imaging in all flight paths is completed, it can be performed at every imaging in multiple flight paths, or at every imaging in each flight path. The processing involved in the estimation of the 3D shape of the object to be imaged BL can be performed on the terminal 80, the UAV 100, or other devices having an information processing device.

In the above configuration example, the terminal controller 81 may obtain the outer shape information of the object to be imaged BL, and based on the imaging distances DP and DPa corresponding to the outer shape information, generate a flight path FCx as a moving path for imaging the side of the object to be imaged BL. The terminal controller 81 may set the imaging positions CP on the flight path FCx, and set the imaging direction DIR at each imaging position CP based on the normal direction of the side of the object to be imaged. As such, it is possible to calculate and set an appropriate flight path, imaging position, and imaging direction for imaging the side of the object to be imaged. In other words, the imaging position and the imaging direction can be set, and the imaging position and the imaging direction can be used for detailed imaging when the object is viewed from the side. Even when imaging a complex-shaped building as the object to be imaged, an appropriate flight path, imaging position, and imaging direction can be easily set to obtain detailed captured images of the side of the object to be imaged. Therefore, it is possible to obtain a captured image with appropriate imaging distance, imaging direction, image quality, and resolution needed for high-precision 3D shape estimation. In addition, input operations from the user such as path setting and imaging information instructions can be omitted, and the setting operations of the flight path and the imaging control information can be automated, and the appropriate flight path, imaging position, and imaging direction can be easily set. In addition, when the imaging distance is set to be short, the flying object can be prevented from colliding with the object.

The terminal controller 81 may calculate an outer shape path having a predetermined imaging distance DP from the outer shape of the side of the object to be imaged BL, and set the outline path as a moving path (e.g., the flight path FCx). As such, an appropriate flight path corresponding to the outer shape of the object to be imaged can be easily calculated and set. The terminal controller 81 may calculate the imaging distance DPa based on the inner angles of the polygon vertices or the curvature of the outer shape in the outer shape data, and calculate the interval to the outer shape path having the calculated imaging distance DPa. The outer shape path can be set as the moving path (e.g., the flight path FCx). As such, an appropriate flight path corresponding to the shape of the object to be imaged can be easily calculated and set. In addition, when the inner angle of the polygon vertex or the curvature of the outer shape of the outer shape data is relatively small, that is, when there are protrusions in the outer shape, the imaging distance can be shortened and an appropriate flight path can be set. In this case, the angle of the side of the object to be imaged as seen from the imaging position can be prevent from becoming too small, and imaging at a small angle in the oblique direction can be reduced. Further, the shadow parts and the occlusion parts can be reduced, and imaging can be performed as close to the front direction as possible. Therefore, it is possible to obtain a captured image having an appropriate amount of information needed for high-precision 3D shape estimation.

The terminal controller 81 may generate a flight path that flies in a substantially horizontal direction at a predetermined height for the side surface of the object to be imaged BL as a flight path. For example, the initial flight path FC1 can be set to fly at an initial height, and the next flight path FCx can be set at a predetermined height above or below the initial height. The terminal controller 81 may generate a first flight path for a predetermined height of the side of the object to be imaged as a flight path, and generate a second flight path that changes the height at the predetermined vertical imaging interval. For example, it is possible to set the initial flight path FC1 to fly at the initial height, and then to set the next flight path FCx at a descending or an ascending height at the predetermined vertical imaging interval Dv.

The terminal controller 81 may calculate points obtained by dividing the flight path FCx as the flight path at a predetermined horizontal imaging interval Dh, and set each point as the imaging position CP. The terminal controller 81 may calculate the representative value of the normal direction of the outer shape of the object to be imaged BL in the imaging range of the imaging position CP, and may set the imaging direction DIR based on the representative value. The terminal controller 81 may sample the shape of the object to be imaged BL at predetermined intervals, perform weighing based on the distance to the imaging position CP of each sampling point, calculate a weighted average value of the angle of the normal direction of each sampling point with respect to a predetermined reference direction, and set the direction based on the weighted average value as the imaging direction DIR. As such, an appropriate imaging direction can be calculated and set based on the direction of the shape of the object to be imaged at each imaging position and the positional relationship. Therefore, when imaging the side of the object to be imaged, it is possible to reduce the shadow parts and the occlusion parts, perform imaging as close to the front direction as possible, and obtain a captured image with an appropriate amount of information needed for high-precision 3D shape estimation.

The terminal controller 81 may generate the imaging control information including the imaging position CP and the imaging direction DIR, send the flight control information including the imaging control information to the flying object through the communication unit 85, and execute flights related to imaging the side of the object to be imaged. As such, the flying object can be controlled based on the set flight path and the imaging control information to fly around the side of the object, and appropriately capture images of the side of the object. Therefore, it is possible to use the setting of the flight path and the imaging control information for side imaging of the imaging control information, as well as to automate the flight and imaging operations during imaging, and to easily obtain appropriately captured images.

The terminal controller 81 may generate a flight path for the side of the object to be imaged to fly in a substantially horizontal direction at a predetermined height as a flight path, generate imaging control information including the imaging position CP and the imaging direction DIR in the first flight path (e.g., the initial flight path FC1) at a predetermined height, send the flight control information including the imaging control information in the first flight path to the flying object through the communication unit 85, such that the flying object can execute the flight along the first flight path and capture images of the side of the object. The terminal controller 81 may further generate a second flight path (e.g., the next flight path FCx) whose height may be changed at a predetermined vertical imaging interval relative to the first flight path. In the second flight path, the terminal controller 81 may further generate the imaging control information including the imaging position CP and the imaging direction DIR, and the flight control information including the imaging control information in the second flight path may be sent to the flying object through the communication unit 85, such that the flying object can execute the flight along the second flight path and capture images of the side of the object. As such, it is possible to generate a flight path that flies in a substantially horizontal direction at a predetermined height to cause the flying object to fly, and while imaging the side of the object to be imaged for each flight path, the next flight path, imaging position, and imaging direction can be set. Therefore, it is possible to use the setting of the flight path and the imaging control information for side imaging of the imaging control information, as well as to automate the flight and imaging operations during imaging, and to easily obtain appropriately captured images.

In addition, in the above embodiments, the information processing device that can perform the processes in the imaging control method has been exemplified as being included in the terminal 80. However, the information processing device may also be disposed in the UAV 100 or other platforms (PC, server device, etc.), and execute the processes in the imaging control method.

Although the present disclosure has been described using the embodiments, the technical scope of the present disclosure is not limited to the scope described in the above-described embodiments. It is apparent to a person skilled in the art that various alterations or improvements are added to the above-described embodiments. It is also apparent from the description of the claims that embodiments with such alterations or improvements can be included in the technical scope of the present disclosure.

It should be noted that the order of carrying out each instance of processing, such as an operation, procedure, step, and stage in a device, system, program, and method shown in the claims, the specification, and the drawings may be implemented in any order unless otherwise indicated by “before” and “prior”, etc., and that the output of the previous instance of processing is not used in subsequent processing. For convenience, even if the operation flow in the claims, specification, and drawings is described using “first,” “next,” or the like, it does not mean that same is necessarily executed in this order.

What is claimed is:

1. An information processing device for generating imaging control information for imaging an object by a moving body, the information processing device comprising a processing unit configured to:
obtain shape information of the object to be imaged;
generate a moving path for imaging a side of the object to be imaged based on an imaging distance corresponding to the shape information;
set an imaging position on the moving path; and
set an imaging direction at the imaging position based on a normal direction of the side of the object to be imaged.

2. The information processing device of claim 1, wherein the processing unit is configured to:
calculate an outer shape path having a predetermined imaging distance from an outer shape of the side of the object to be imaged; and
set the outer shape path as the moving path.

3. The information processing device of claim 2, wherein the processing unit is configured to:
calculate the imaging distance based on an inner angle of a polygon vertex in outer shape data of the object to be imaged or a curvature of the outer shape of the object to be imaged;
calculate the outer shape path having the calculated imaging distance; and
set the outer shape path as the moving path.

4. The information processing device of claim 1, wherein the processing unit is configured to:
generate a flight path flying in a substantially horizontal direction at a predetermined height with respect to the side of the object to be imaged as the moving path.

5. The information processing device of claim 4, wherein the processing unit is configured to:
generate a first flight path at the predetermined height with respect to the side of the object to be imaged; and
generate a second flight path having a height that changes at a predetermined vertical imaging interval as the moving path.

6. The information processing device of claim 1, wherein the processing unit is configured to:
calculate points obtained by diving the moving path at a predetermined horizontal imaging interval; and
set each point as the imaging position.

7. The information processing device of claim 1, wherein the processing unit is configured to:
calculate a representative value of the normal direction of the outer shape of the object to be imaged within an imaging range of the imaging position; and
set the imaging direction based on the representative value.

8. The information processing device of claim 7, wherein the processing unit is configured to:
sample the outer shape of the object to be imaged at predetermined intervals;
perform weighting based on a distance to the imaging position of each sampling point;
calculate a weighted average of an angle of the normal direction of each sampling point with respect to a predetermined reference direction; and
set a direction of the weighted average as the imaging direction.

9. The information processing device of claim 1 further comprising a communication unit, and the processing unit being configured to:
generate the imaging control information including the imaging position and the imaging direction;
send flight control information including the imaging control information to the moving body through the communication unit; and
cause the moving body to execute flight and imaging related to the side of the object to be imaged.

10. The information processing device of claim 1 further comprising a communication unit, and the processing unit being configured to:
generate a flight path flying in a substantially horizontal direction at a predetermined height with respect to the side of the object to be imaged and set the flight path as the moving path;
generate the imaging control information including the imaging position and the imaging direction on a first flight path at the predetermined height;
send flight control information including the imaging control information in the first flight path to the moving body through the communication unit;
cause the moving body to execute a flight of the first flight path and image the side of the object to be imaged;
generate a second flight path having a height that changes at a predetermined vertical imaging interval relative to the first flight path;
generate the imaging control information including the imaging position and the imaging direction on the second flight path;
send the flight control information including the imaging control information in the second flight path to the moving body through the communication unit; and
cause the moving body to execute a flight of the second flight path and image the side of the object to be imaged.

11. An imaging control method of an information processing device for generating imaging control information for imaging an object to be imaged through a moving body, comprising:
obtaining shape information of the object to be imaged;
generating a moving path for imaging a side of the object to be imaged based on an imaging distance corresponding to the shape information;
setting an imaging position on the moving path; and
setting an imaging direction at the imaging positon based on a normal direction of the side of the object to be imaged.

12. The imaging control method of claim 11, wherein generating the moving path includes:
calculating an outer shape path having a predetermined imaging distance from an outer shape of the side of the object to be imaged; and
setting the outer shape path as the moving path.

13. The imaging control method of claim 12, wherein generating the moving path includes:
calculating the imaging distance based on an inner angle of a polygon vertex in outer shape data of the object to be imaged or a curvature of the outer shape of the object to be imaged;
calculating the outer shape path having the calculated imaging distance; and
setting the outer shape path as the moving path.

14. The imaging control method of claim 11, wherein generating the moving path includes:
generating a flight path flying in a substantially horizontal direction at a predetermined height with respect to the side of the object to be imaged as the moving path.

15. The imaging control method of claim 14, wherein generating the moving path includes:
generating a first flight path at the predetermined height with respect to the side of the object to be imaged; and
generating a second flight path having a height that changes at a predetermined vertical imaging interval as the moving path.

16. The imaging control method of claim 11, wherein setting the imaging position includes:
calculating points obtained by diving the moving path at a predetermined horizontal imaging interval; and
setting each point as the imaging position.

17. The imaging control method of claim 11, wherein setting the imaging position includes:
calculating a representative value of the normal direction of the outer shape of the object to be imaged within an imaging range of the imaging position; and
setting the imaging direction based on the representative value.

18. The imaging control method of claim 17, wherein setting the imaging position includes:
sampling the outer shape of the object to be imaged at predetermined intervals;
performing weighting based on a distance to the imaging position of each sampling point;
calculating a weighted average of an angle of the normal direction of each sampling point with respect to a predetermined reference direction; and
setting a direction of the weighted average as the imaging direction.

19. The imaging control method of claim 11, further comprising:
generating the imaging control information including the imaging position and the imaging direction;
sending flight control information including the imaging control information to the moving body; and
causing the moving body to execute flight and imaging related to the side of the object to be imaged.

20. The imaging control method of claim 11, further comprising:
generating a flight path flying in a substantially horizontal direction at a predetermined height with respect to the side of the object to be imaged and set the flight path as the moving path;
generating the imaging control information including the imaging position and the imaging direction on a first flight path at the predetermined height;
sending flight control information including the imaging control information in the first flight path to the moving body;
causing the moving body to execute a flight of the first flight path and image the side of the object to be imaged;
generating a second flight path having a height that changes at a predetermined vertical imaging interval relative to the first flight path;
generating the imaging control information including the imaging position and the imaging direction on the second flight path;
sending the flight control information including the imaging control information in the second flight path to the moving body; and
causing the moving body to execute a flight of the second flight path and image the side of the object to be imaged.
